(19) United States
(12) Patent Application Publication
(10) Pub. No.: US 2013/0322278 A1
(43) Pub. Date: Dec. 5, 2013

(54) FEEDBACK METHOD AND APPARATUS FOR COOPERATIVE TRANSMISSION OF MULTIPLE CELLS

(71) Applicant: Samsung Electronics Co. Ltd., Suwon-si (KR)

(72) Inventors: Hyojin LEE, Suwon-si (KR); Younsun KIM, Seongnam-si (KR); Juho LEE, Suwon-si (KR)

(21) Appl. No.: 13/907,112

(22) Filed: May 31, 2013

Related U.S. Application Data
(60) Provisional application No. 61/654,259, filed on Jun. 1, 2012.

(51) Int. Cl. H04W 72/08

(52) U.S. Cl. CPC H04W 72/085
USPC 370/252

(57) ABSTRACT

A method and an apparatus for an interference measurement method of a terminal in a mobile communication system is provided. The method includes measuring a signal component based on at least one Channel Status Information-Reference Signal (CSI-RS) allocated by a base station, measuring an interference component based on at least one Interference Measurement Resource (IMR) allocated by a base station, receiving a feedback combination configuration of the signal component and the interference component, generating feedback information including at least one of at least one Channel Quality Indicator (CQI), at least one Rank Indicator (RI), and at least one Precoding Matrix Indicator (PMI), and transmitting the feedback information to the base station.

### CROSS-REFERENCE TO RELATED APPLICATIONS

This application claims the benefit under 35 U.S.C. §119(e) of a U.S. Provisional application filed on Jun. 1, 2012 in the U.S. Patent and Trademark Office and assigned Ser. No. 61/654,259, the entire disclosure of which is hereby incorporated by reference.

### BACKGROUND OF THE INVENTION

1. Field of the Invention

The present invention relates to a feedback method and apparatus for a cellular mobile communication system including plural base stations. More particularly, the present invention relates to a method and apparatus for transmitting feedback information efficiently for use in a Cooperative Multi-Point downlink transmission of multiple base stations.

2. Description of the Related Art

A portable terminal may be equipped with a touch panel and a camera so as to process and store an image taken by the camera and so as to receive a user input for controlling the operation of the terminal and enter data by means of the touch panel. More recently, the portable terminal may include text and speech recognition functions.

A mobile communication system has evolved into a high-speed, high-quality wireless packet data communication system to provide data and multimedia services beyond the early voice-oriented services. Recently, various mobile communication standards, such as High Speed Downlink Packet Access (HSDPA), High Speed Uplink Packet Access (HSUPA), Long Term Evolution (LTE), and LTE-Advanced (LTE-A) defined by the 3rd Generation Partnership Project (3GPP), High Rate Packet Data (HRPD) defined by the 3rd Generation Partnership Project-2 (3GPP2), and 802.16 defined by the Institute for Electrical and Electronics Engineers (IEEE), have been developed to support the high-speed, high-quality wireless packet data communication services.

Particularly, LTE is a communication standard developed to support high speed packet data transmission and to maximize the throughput of the radio communication system with various radio access technologies. LTE-A is the evolved version of LTE to improve the data transmission capability. The existing 3rd generation wireless packet data communication systems, including HSDPA, HSUPA and HRPD, adopt Adaptive Modulation and Coding (AMC) and Channel-Sensitive Scheduling techniques to improve the transmission efficiency.

In a wireless packet data communication system adopting AMC, a transmitter may adjust the data transmission amount based on a channel condition. That is, the transmitter decreases the data transmission amount for a bad channel condition so as to fix the received signal error probability at a certain level and increases the data transmission amount for a good channel condition so as to transmit large amount of information efficiently while maintaining the received signal error probability at an intended level.

In the wireless packet data communication system adopting channel sensitive scheduling, the transmitter serves the user having good channel condition first among a plurality of users so as to increase the system capacity as compared to allocating a channel to one user. Such increase of system capacity is referred to as multi-user diversity gain. In a case of using AMC along with a Multiple Input Multiple Output (MIMO) transmission scheme, a number of spatial layers and ranks for transmitting signals should be taken into consideration. In this case, the transmitter determines the optimal data rate in consideration of the number of layers for use in MIMO transmission.

In general, Orthogonal Frequency Division Multiple Access (OFDMA) is expected to provide superior system throughput as compared to Code Division Multiple Access (CDMA). One of the main factors that allows OFDMA to increase system throughput is the frequency domain scheduling capability. As channel sensitive scheduling increases the system capacity using a time-varying channel characteristic, OFDMA may be used to obtain more capacity gain using the frequency-varying channel characteristic. Recently, research is being conducted to replace CDMA used in legacy 2nd and 3rd generation mobile communication systems with OFDMA for the next generation mobile communication system. The 3GPP and 3GPP2 are in the process of standardization of OFDMA-based evolved system.

FIG. 1 is a diagram illustrating a cellular mobile communication system in which a transmit/receive antennas are arranged at the center of the cells according to the related art.

Referring to FIG. 1, in the cellular mobile communication system composed of a plurality of cells, a User Equipment (UE) receives mobile communication service from a cell selected for a semi-static duration with the above described techniques. Suppose that the cellular mobile communication system includes three cells 100, 110, and 120. Also, suppose the cell 100 serves UEs 101 and 102 within its service area, the cell 110 serves UE 111, and the cell 120 serves UE 121. The UE 102 served by the cell 100 is located far from antenna 130 as compared to the UE 101. In this case, the UE 102 experiences significant interference from the central antenna of the cell 120 so as to be served by the UE 100 at relatively low data rate.

In a case where the cells 100, 110, and 120 provide the mobile communication service independently, they transmit a Reference Signal (RS) for downlink channel estimation at the recipient. Particularly in the 3GPP LTE-A system, the UE measures the channel condition between an evolved Node B (eNB) and itself using a Channel Status Information Reference Signal (CSI-RS) transmitted by the eNB.

FIG. 2 is a diagram illustrating a configuration of a resource block including a CSI-RS transmitted from an eNB to a UE in the LTE-A system according to the related art.

Referring to FIG. 2, two CSI-RS antenna port signals are mapped to each of the positions 200 through 219. For example, the eNB transmits two CSI-RSs for downlink measurement to the UE at the position 200. In a case of the cellular mobile communication system including a plurality of cells, as depicted in FIG. 1, the CSI-RS is transmitted in different positions corresponding to the respective cells. For example, the CSI-RS is transmitted at the position 200 for the cell 100, the position 205 for the cell 110, and the position 210 for the cell 120. The cells are allocated resources at different positions for the CSI-RS transmission so as to prevent the CSI-RSs of different cells from interfering among each other.

The UE estimates a downlink channel using the CSI-RS to feed back a Rank Indicator (RI), a Channel Quality Indicator (CQI), and a Precoding Matrix Indicator (PMI), as estimated channel information, to the eNB. The UE performs feedback periodically on a Physical Uplink Control Channel (PUCCH) in one of the following 4 feedback modes:

Mode 1-0: RI, wideband CQI (wCQI);

Mode 1-1: RI, wCQI, wideband PMI (wPMI);

Mode 2-0: RI, wCQI, subband CQI (sCQI); and

Mode 2-1: RI, wCQI, wPMI, sCQI, sPMI.

A feedback timing in a respective feedback mode is determined based on I_{CQI/PMI} transmitted through high layer signaling and N_{pd}, N_{OFFSET,CQI}, M_{RI}, N_{OFFSET,RI} corresponding to I_{RI}. In Mode 1-0, a wCQI transmission period is N_{pd}, and the feedback timing is determined based on a subframe offset value of N_{OFFSET,CQI}. A RI transmission period is N_{pd}. M_{RI}, and a RI transmission period offset is N_{OFFSET,CQI}+N_{OFFSET,RI}.

FIG. 3 is a diagram illustrating feedback timings of a UE in feedback modes 1-0 and 1-1 in an LTE-A system according to the related art.

Referring to FIG. 3, the RI and wCQI feedback timings in the case of N_{pd}=2, M_{RI}=2, N_{OFFSET,CQI}=1, and N_{OFFSET,RI}=−1 are shown. Here, each timing indicates a subframe index, and the feedback mode 1-1 has the same timings as the feedback mode 1-0 with the exception that the PMI is transmitted together with the wCQI.

In the feedback mode 2-0, the sCQI feedback period is N_{pd} with offset N_{OFFSET,CQI}. The wCQI feedback period is H·N_{pd} with offset N_{OFFSET,CQI} equal to the sCQI offset. Here, H=J·K+1, where K is transmitted through a higher layer signal and J is determined according to the system bandwidth. For example, J is determined to be 3 in the 10 MHz system. This means that the wCQI is transmitted at every H sCQI transmissions in replacement of sCQI. The RI period is M_{RI}·H·N_{pd} with offset N_{OFFSET,CQI}+N_{OFFSET,RI}.

FIG. 4 is a diagram illustrating feedback timings of a UE in feedback modes 2-0 and 2-1 in an LTE-A system according to the related art.

Referring to FIG. 4, the RI, sCQI, and wCQI feedback timings in the case of N_{pd}=2, M_{RI}=2, J=3 (10 MHz), K=1, N_{OFFSET,CQI}=1, and N_{OFFSET,RI}=−1 are shown. The feedback mode 2-1 is identical with the feedback mode 2-0 in feedback timings with the exception that PMI and the wCQI are transmitted together.

Unlike the feedback timings for the case of 4 CSI-RS antenna ports, as described above, two PMIs are transmitted for 8 CSI-RS antenna ports. For 8 CSI-RS antenna ports, the feedback mode 1-1 is divided into two sub-modes. In the first sub-mode, the first PMI is transmitted along with the RI and the second PMI along with the wCQI. Here, the wCQI and second PMI feedback period and offset are defined as N_{pd} and N_{OFFSET,CQI}, and the RI and the first PMI feedback period and offset are defined as M_{RI}·N_{pd} and N_{OFFSET,CQI}+N_{OFFSET,RI}, respectively.

For the 8 CSI-RS antenna ports, the feedback mode 2-1 adopts new information of a Precoding Type Indicator (PTI), which is transmitted along with RI at period of M_{RI}·H·N_{pd} with the offset of N_{OFFSET,CQI}+N_{OFFSET,RI}. For a PTI=0, the first and second PMIs and wCQI are transmitted, particularly the wCQI and second PMI are transmitted at the same timing at a period N_{pd} with an offset of N_{OFFSET,CQI}. Meanwhile, the first PMI is transmitted at a period of N_{pd} with an offset of N_{OFFSET,CQI}. Here, H′ is transmitted through higher layer signaling. For a PTI=1, the PTI and RI are transmitted at the same timing, the wCQI and the second PMI are transmitted at the same timing, and the sCQI is transmitted additionally. In this case, the first PMI is not transmitted. The PTI and the RI are transmitted at a same period with the same offset as the case of PTI=0, and the sCQI is transmitted at a period of N_{pd} with an offset of N_{OFFSET,CQI}. Also, the wCQI and the second PMI are transmitted at a period of H·N_{pd} with an offset of N_{OFFSET,CQI}, and H is set to the same value as the case of 4 CSI-RS antenna ports.

FIG. 5 is a diagram illustrating feedback timings of a UE in feedback modes 2-0 and 2-1 in an LTE-A system according to the related art, and FIG. 6 is a diagram illustrating feedback timings of a UE in feedback modes 2-0 and 2-1 in an LTE-A system according to the related art.

Referring to FIGS. 5 and 6, the feedback timings for PTI=0 and PTI=1 with N_{pd}=2, M_{RI}=2, J=3 (10 MHz), K=1, H′=3, N_{OFFSET,CQI}=1, and N_{OFFSET,RI}=−1, are respectively shown. A related art channel information feedback method designed in consideration of the situation of CSI feedback is not appropriate for use in Coordinated Multi-Point (COMP) transmission requiring feedback of multiple CSIs. Accordingly, there is a need for a feedback method for multiple CSIs feedback situation.

In a case of the cellular mobile communication system depicted in FIG. 1, a UE located at a cell edge is limited in data rate due to the significant interference from neighbor cells. This means that the data rate of the UE is influenced significantly by its location within the cell in the cellular mobile communication system depicted in FIG. 1. That is, although the related art cellular mobile communication system may serve the UE located near the center of the cell at a high data rate, it is restricted to serve the UE located far from the center of the cell at such a data rate.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a simplified Cooperative Multi-Point (CoMP) transmission method and provide a feedback information generation method and apparatus for efficient CoMP transmission in a Long Term Evolution-Advanced (LTE-A) system.

In accordance with an aspect of the present invention, an interference measurement method of a terminal in a mobile communication system is provided. The method includes measuring a signal component based on at least one Channel Status Information-Reference Signal (CSI-RS) allocated by a base station, measuring an interference component based on at least one Interference Measurement Resource (IMR) allocated by a base station, receiving a feedback combination configuration of the signal component and the interference component, generating feedback information including at least one of at least one Channel Quality Indicator (CQI), at least one Rank Indicator (RI), and at least one Precoding Matrix Indicator (PMI), and transmitting the feedback information to the base station.

In accordance with another aspect of the present invention, an interference measurement method of a base station in a mobile communication system is provided. The method includes allocating at least one CSI-RS for measuring a signal component and at least one IMR for measuring an interference component to a terminal, transmitting a feedback combination configuration of the signal component and the interference component, and receiving feedback information including at least one of at least one CQI, at least one RI, and at least one PMI generated by the terminal based on the feedback combination configuration.

In accordance with another aspect of the present invention, a terminal of a mobile communication system is provided. The terminal includes a transceiver transmitting and receiving signals to and from a base station, and a control unit controlling measuring a signal component based on at least one CSI-RS allocated by a base station, measuring an interference component based on at least one IMR allocated by a base station, receiving a feedback combination configuration of the signal component and the interference component, generating feedback information including at least one of at least one CQI, at least one RI, and at least one PMI, and transmitting the feedback information to the base station.

In accordance with still another aspect of the present invention, a base station of a mobile communication system is provided. The base station includes a transceiver transmitting and receiving signals to and from a terminal, and a control unit controlling the transceiver, allocating at least one CSI-RS for measuring a signal component and at least one IMR for measuring an interference component to a terminal, transmitting a feedback combination configuration of the signal component and the interference component, and receiving feedback information including at least one of at least one CQI, at least one RI, and at least one PMI generated by the terminal based on the feedback combination configuration.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a diagram illustrating a cellular mobile communication system in which the transmit/receive antenna are arranged at the center of the cells according to the related art;

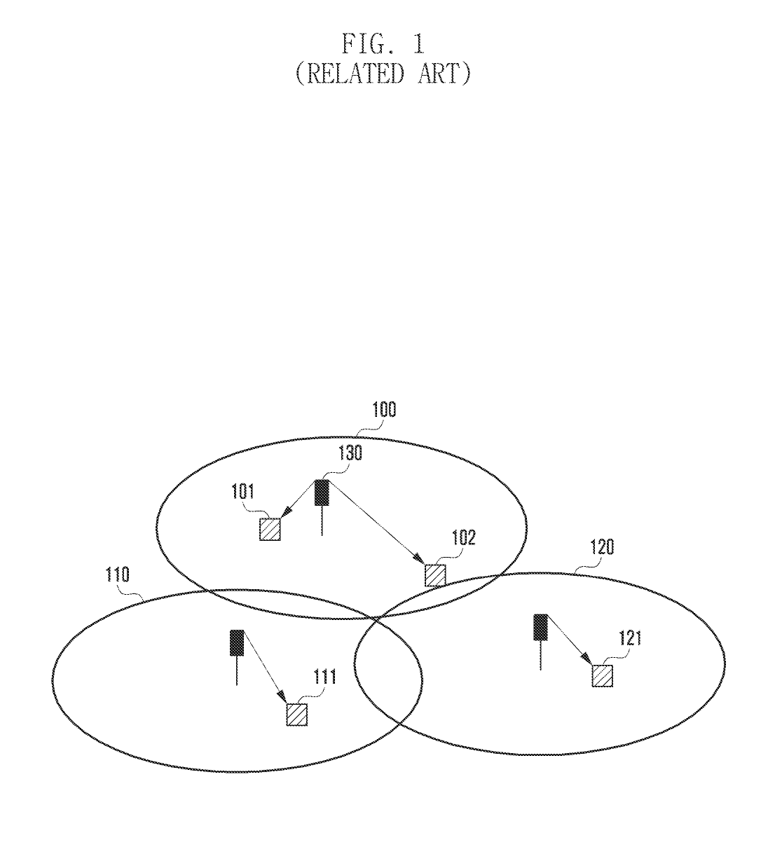

FIG. 2 is a diagram illustrating a configuration of a resource block including Channel Status Information Reference Signal (CSI-RS) transmitted from an evolved Node B (eNB) to a User Equipment (UE) in an Long Term Evolution-Advanced (LTE-A) system according to the related art;

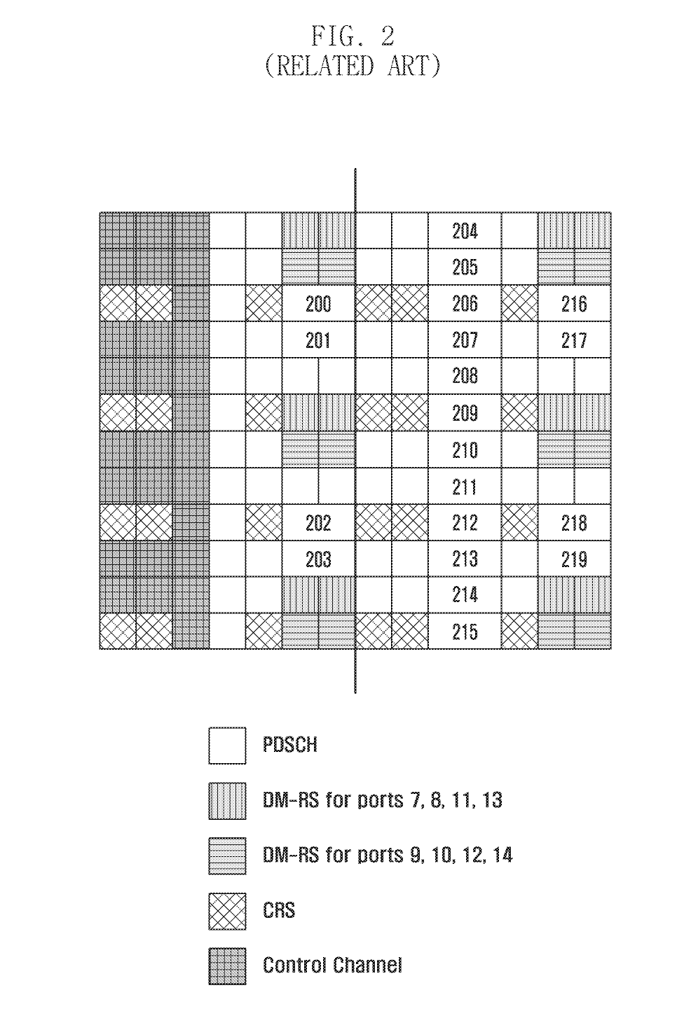

FIG. 3 is a diagram illustrating feedback timings of a UE in feedback modes 1-0 and 1-1 in an LTE-A system according to the related art;

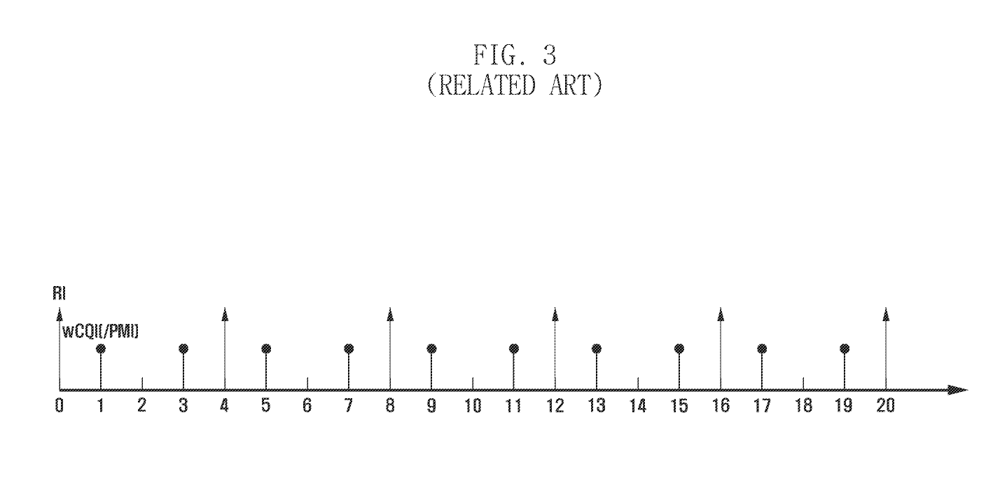

FIG. 4 is a diagram illustrating feedback timings of a UE in feedback modes 2-0 and 2-1 in an LTE-A system according to the related art;

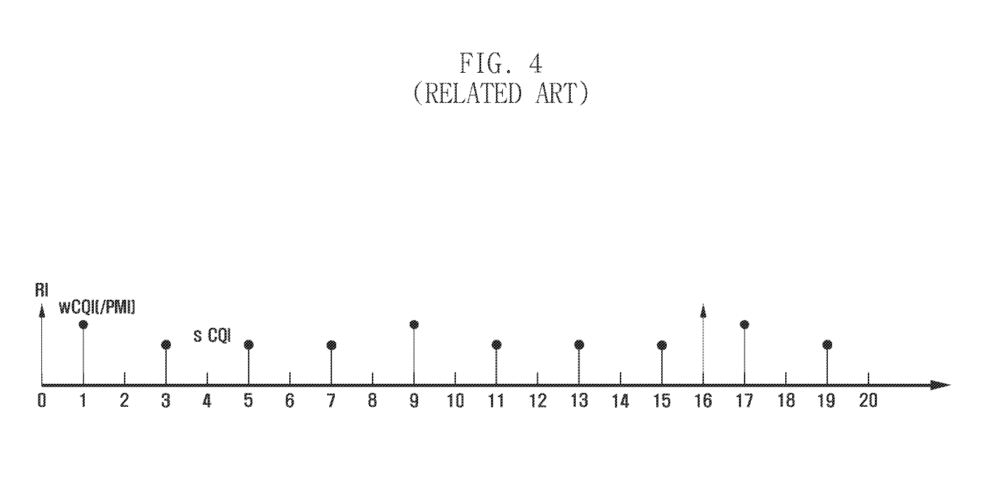

FIG. 5 is a diagram illustrating feedback timings of a UE in feedback modes 2-0 and 2-1 in an LTE-A system according to the related art;

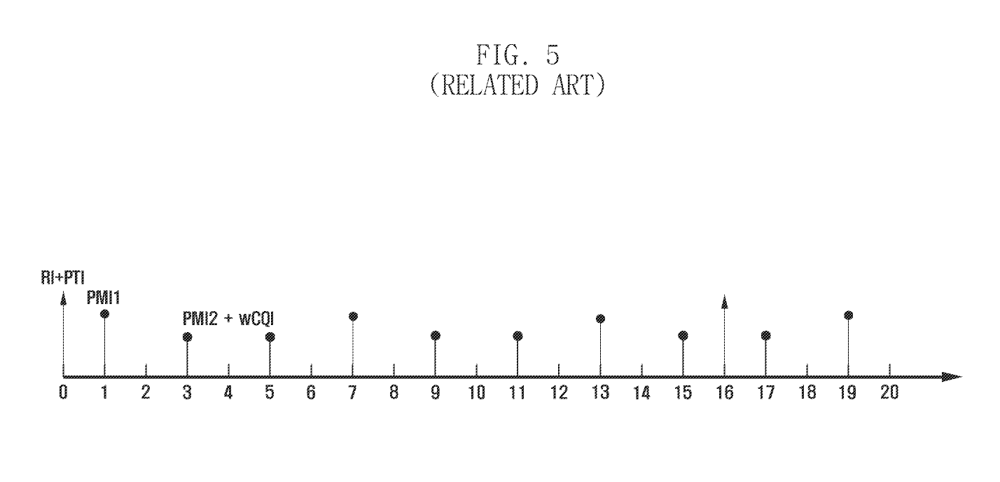

FIG. 6 is a diagram illustrating feedback timings of a UE in feedback modes 2-0 and 2-1 in an LTE-A system according to the related art;

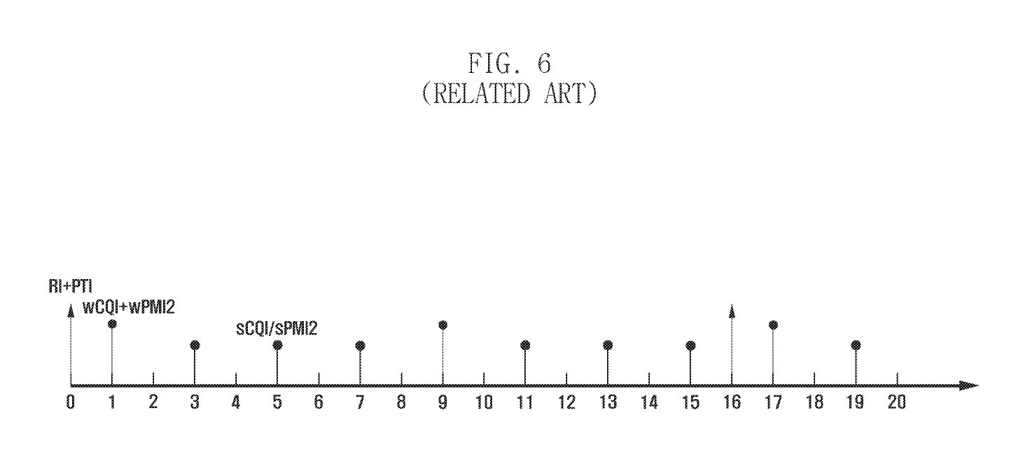

FIG. 7 is a diagram illustrating a configuration of a cellular mobile communication system according to an exemplary embodiment of the present invention;

FIG. 8 is a diagram illustrating a configuration of a resource block including a CSI-RS transmitted from an eNB to a UE in a cellular mobile communication system according to an exemplary embodiment of the present invention;

FIG. 9 is a flowchart illustrating a first method for a UE to feed back a delta_CQI to an eNB according to an exemplary embodiment of the present invention;

FIG. 10 is a flowchart illustrating a second method for a UE to feed back a delta_CQI to an eNB according to an exemplary embodiment of the present invention;

FIG. 11 is a flowchart illustrating a third method for a UE to feed back a delta_CQI feedback to an eNB according to an exemplary embodiment of the present invention;

FIG. 12 is a block diagram illustrating a configuration of a UE according to an exemplary embodiment of the present invention; and

FIG. 13 is a block diagram illustrating a configuration of a central controller according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Although the exemplary embodiments described herein are directed to an Orthogonal Frequency Division Multiplexing (OFDM)-based radio communication system, particularly a 3^{rd} Generation Partnership Project (3GPP) Evolved Universal Terrestrial Radio Access (EUTRA), the present invention is not limited thereto, and may be applied to other similar and/or suitable communication systems having the similar technical backgrounds and channel formats, without departing from the spirit and scope of the present invention.

For the same reason, some of elements are exaggerated, omitted or simplified in the drawings and the elements may have sizes and/or shapes different from those shown in drawings, in practice. The same reference numbers are used throughout the drawings to refer to the same or like parts.

Advantages and features of the present exemplary embodiments and methods of accomplishing the same may be understood more readily by reference to the following detailed description of exemplary embodiments and the accompanying drawings. The present exemplary embodiments may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, when included in hardware elements are elements for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Furthermore, the respective block diagrams may illustrate parts of modules, segments or codes including at least one or more executable instructions for performing specific logic functions. Moreover, it should be noted that the functions of the blocks may be performed in different order in several modifications. For example, two successive blocks may be performed substantially at the same time, or may be performed in reverse order according to their functions.

The term “module” according to the exemplary embodiments of the present invention, may refer to, but is not limited to, a software or hardware component, such as a Field Programmable Gate Array (FPGA), an Application Specific Integrated Circuit (ASIC), an Integrated Circuit, or any other similar and/or suitable hardware element, which performs certain tasks. A module may advantageously be configured to reside on the addressable storage medium and configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more Central Processing Units (CPUs) in a device or a secure multimedia card.

The cellular mobile communication system is composed of a plurality of cells deployed within a restricted area. A cell is defined as a geographic area where a User Equipment (UE) is served by an evolved Node B (eNB) apparatus. A UE is served by a cell which is selected semi-statically. Such a system is referred to as non-Coordinated Multi-Point (CoMP) system hereinafter. In the non-CoMP system, the UE is assigned a data rate which varies significantly according to its location within the cell. The UE located near the center of the cell is assigned a high data rate while the UE located far from the center of the cell may not be assigned such a high data rate.

A CoMP system is opposite to the non-CoMP one. The CoMP system is the system in which multiple cells cooperate for data transmission to the UE located at cell edge. The CoMP system may be advantageous to the non-CoMP system in quality of mobile communication service. The present exemplary embodiment provide a feedback method and apparatus operating based on the Dynamic cell Selection (DS) and Dynamic cell Blanking (DB) techniques that are characterized by relatively simple operations and improved performance. The DS is a method for the UE to measure the channel condition per cell and select the cell having the optimized channel. The DB is a method for one or more cells that are potentially producing interference mute data transmission for predetermined time duration. The present exemplary embodiments modify the feedback structure so as to apply the DS or DB technique to a Long Term Evolution-Advanced (LTE-A) system to address the aforementioned problems.

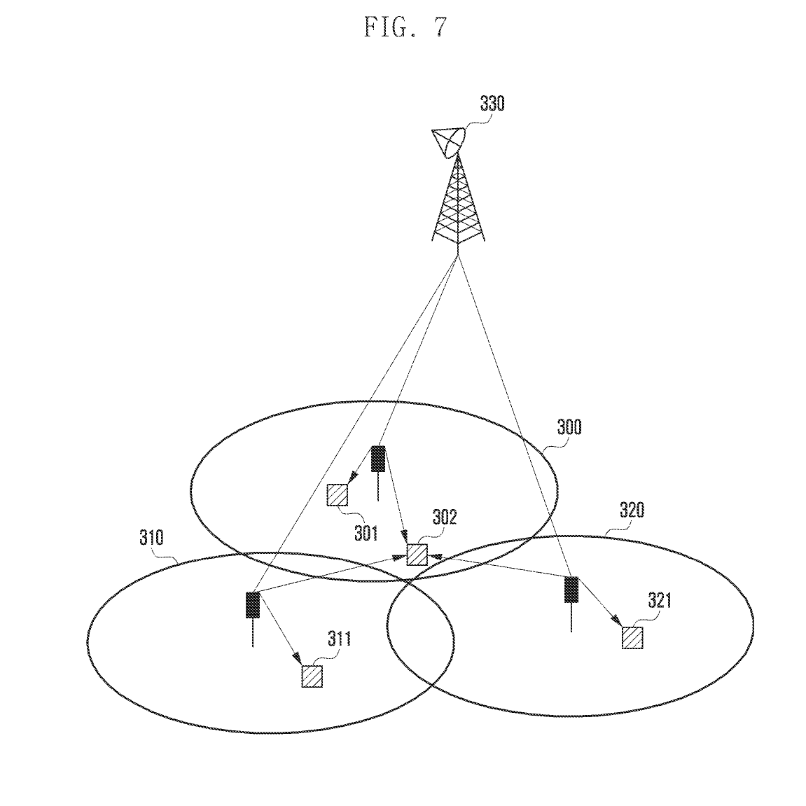

FIG. 7 is a diagram illustrating a configuration of a cellular mobile communication system according to an exemplary embodiment of the present invention.

Referring to FIG. 7, a cellular mobile communication system may be composed of three cells. In the present exemplary embodiment, a cell may refer to a service area centered around a specific transmission point, which may be a Remote Radio Head (RRH) sharing a cell Identifier (ID) with a macro evolved Node B (eNB) within a macro cell or a macro or pico cell having a unique cell ID. A central controller is an apparatus that communicates data with UEs and processes the data. In a case where the transmission point is the RRH sharing a cell ID with the macro eNB, the macro eNB may be referred to as the central controller. In a case where the transmission point is the macro or pico cell having a unique cell ID, an apparatus managing the cells integrally may be referred to as the central controller.

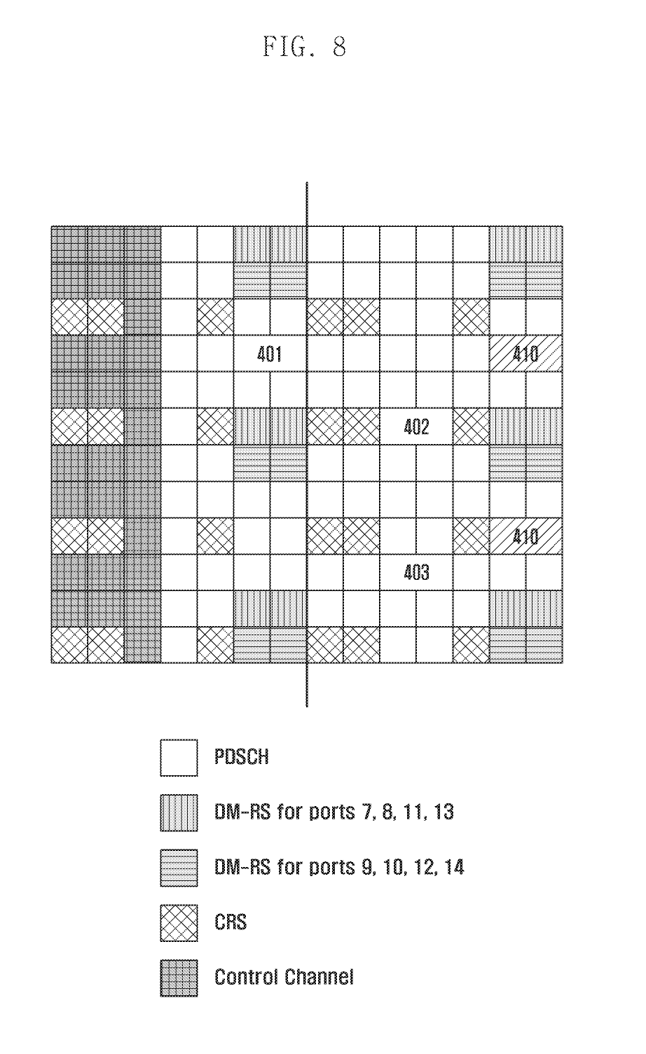

Referring to FIG. 7, the cellular mobile communication system includes cells 300, 310 and 320, UEs 301, 311, and 321, which receive data from the nearest cell from among the cells 300, 310, and 320, and a UE 302 which receives data in a CoMP transmission from the cells 300, 310, and 320. The UEs which receive data from the nearest cell from among the cells 301, 311, and 321 perform channel estimation based on a Channel Status Information Reference Signal (CSI-RS) for the cell in which the UEs are located and transmit the corresponding feedback to a central controller 330. However, the UE 302, which is served in CoMP transmission from the cells 300, 310, and 320, performs channel estimation for all three of the cells 300, 310, and 320. In order for the UE 302 to perform channel estimation, the central controller 330 assigns three CSI-RSs corresponding to the cells participating in the CoMP transmission for the UE 302. A description is made of the CSI-RS allocation method with reference to FIG. 8.

FIG. 8 is a diagram illustrating a configuration of a resource block including a CSI-RS transmitted from an eNB to a UE in a cellular mobile communication system according to an exemplary embodiment of the present invention.

Referring to FIGS. 7 and 8, the central controller 330 allocates resources 401, 402, and 403 for three CSI-RSs such that a UE receiving a CoMP transmission is capable of estimating channels from the cells 300, 310, and 320. The resources 401, 402, and 403 are allocated to correspond to the CSI-RSs for channel estimations in the respective cells. Resource 401 is a resource allocated to the CSI-RS for channel estimation in the cell 300, resource 402 is a resource allocated to a CSI-RS for channel estimation in the cell 402, and resource 403 is a resource allocated to a CSI-RS for channel estimation in the cell 403. A set of resources to which at least one CSI-RS transmitted for use in channel estimation of the CoMP UE is mapped or a set of cells corresponding to the resources is referred to as measurement set.

The central controller 330 may allocate additional resources to the UE 302 for interference measurement. The data amount that the UE can receive in a given time is influenced by the interference as well as the signal strength. Accordingly, the central controller 330 may allocate an Interference Measurement Resource (IMR) dedicated for the UE in order for the UE to measure interference to acquire an accurate interference measurement. The eNB may allocate one IMR to a UE to measure the interference amount applied commonly to all CSI-RS components within the measurement set or may allocate multiple IMRs to a UE to measure the interferences in various situations. Referring to FIG. 8, the UE measures the signals from the cells 300, 310, and 320 using the CSI-RS resources 401, 402, and 403, and measures the interference occurring when receiving the signals from the cells 300, 310, and 320 using the IMR 410. At this time, the eNB controls the signal transmissions of the neighbor cells at the resource 410 in order for the UE to accurately measure interference.

An exemplary embodiment of the present invention proposes types of feedback for a case where a UE is allocated one or more IMRs with a measurement set of plural cells, feedback generation and transmission methods, eNB's feedback resource allocation method, and UE's feedback operation.

In a case where the UE obtains a measurement set of cells and is allocated one or more IMRs, the eNB requests the UE for multiple feedbacks for the available signals and interferences and the UE generates feedback information and transmits the feedback information at predetermined feedback transmission timings. In a case where the measurement set is {CSI-RS-1, CSI-RS-2}, the CSI-RS-1 and the CSI-RS-2 are transmitted from the respective Cell-1 and Cell-2, and the eNB allocates one IMR to the UE and the IMR reflects the interferences from cells output of the measurement group. In such a case, the eNB may request the UE for four different types of feedback (FB) corresponding to signals and interference, as listed in Table 1, and the UE performs feedback in the feedback type requested by the eNB. Each feedback is configured with the timing information of I_{CQI/PMI} and I_{RI}.

TABLE 1

| Feedback | Signal component | Interference | Consideration |
|---|---|---|---|
| FB 1 | Cell-1 | IMR + Cell-2 | No blanking |
| FB 2 | Cell-1 | IMR | Blanking of Cell-2 |
| FB 3 | Cell-2 | IMR + Cell-1 | No blanking |
| FB 4 | Cell-2 | IMR | Blanking of Cell-1 |

Table 1 summarizes the feedback types for various signal and interference conditions. In Table 1, IMR+Cell-2 denotes that the UE takes the sum of the interference measured at the IMR and the interference measured at the CSI-RS-2 position corresponding to Cell-2 as the total interference in the feedback FB1. That is, the UE, in the feedback FB1, transmits the CSI for the situation of receiving the signal from Cell-1 with the interference from Cell-2 and the cells out of the measurement set that are reflected at the IMR. Meanwhile, the UE, in the feedback FB 2, transmits the CSI for the situation of receiving the signal from Cell-1 with the interference from the cells out of the measurement set that are reflected at the IMR while Cell-2 is in a blank state transmitting no signal.

Here, the CSI transmitted in the feedback FB 1 or the feedback FB 2 may include individual RI, PMI, and CQI, or a common RI/PMI plus individual CQI. The common RI/PMI may include at least one common RI and a common PMI. A determination of whether to transmit the individual RI, PMI, and CQI or the common RI/PMI plus individual CQI may be based on higher Radio Resource Control (RRC) signaling from the eNB. That is, assuming that there is a RRC signal named RI/PMI_commonality, if the RI/PMI_commonality signal is ON, then the UE transmits one shared RI and PMI, but the individual CQI is transmitted individually and, otherwise if the RI/PMI_commonality signal is OFF, then the UE transmits the individual RI, PMI, and CQI at individual feedback timings for feedbacks.

According to another exemplary embodiment, in order to determine whether to configure the CSI to include the individual RI, PMI, and CQI or include the common RI/PMI plus the individual CQI, the RI and PMI common to the feedbacks may be made to have the same timing while generating the CQI individually and then encoding the common RI/PMI and the individual CQI to be fed back at the same timing. That is, if the I_{CQI/PMI} and the I_{RI}, defining the timings in the feedback FB1, and the I_{CQI/PMI} and the I_{RI}, defining the timings in the feedback FB 2, are set to the same values, then the UE may determine the RI and the PMI to be generated in common and may determine the CQI to be generated individually and that they are encoded to be fed back at the same timings.

In the feedback including the common RI/PMI plus the individual CQI, the RI and the PMI to be referenced may be notified by the eNB through higher layer signaling or may be determined in an order of a feedback request index. The RI or the PMI to be referenced among the common RI and PMI may be determined based on the higher layer signal transmitted by the eNB or may be determined in an order of feedback indices. In the following description of an exemplary embodiment, the feedback as the basis for generating RI and PMI in the common RI/PMI plus the individual CQI feedback schemes is referred to as reference feedback. That is, if the higher layer signaling is used for notification of the reference feedback, then the eNB designates one of the feedback FB 1 and the feedback FB 2 for the common RI/PMI.

Additionally, if the feedback request index is used, and since the feedback FB 1 and the feedback FB 2 have indices 1 and 2 respectively, then the RI and the PMI are shared for the feedback FB 1 with a low index in common and the CQI for the feedback FB 2 with a high index remains individual. Another method for determining the reference feedback of the RI/PMI is to follow the types of the interference components corresponding to the related feedbacks. That is, the feedback with many or small interference components may be determined as the reference feedback. For example, since the feedback FB 1 has two interference components of the IMR and the CSI-RS-2 while the feedback FB 2 has one interference component of the IMR, the feedback FB 1 having more interference components or the feedback FB 2 having less interference components is determined as the reference feedback.

In the same way, the UE, in both the feedback FB 3 and the feedback FB 4, transmits the CSI generated based on the signal received from Cell-2 with and without the blank state of Cell-1. Here, the IMR+Cell-1 denotes that the UE takes the sum of the interference measured at the IMR and the interference measured at the CSI-RS-1 position corresponding to cell-1 as total interference in the feedback FB 3. Like the feedback FB 1 and the feedback FB 2, the CSI transmitted in the feedback FB 3 or the feedback FB 4 may include the individual RI, PMI, and CQI or the common RI/PMI plus the individual CQI since they use the same signal component and different interference components. That is, the feedback FB 3 and the feedback FB 4 may be configured to carry the common RI/PMI for the same signal component and the individual CQI for respective interference situations. Also, the common RI/PMI may have a common value of the RI or the PMI.

The RI/PMI reflecting spatial characteristics is not expected to change drastically, and thus, it is possible to reduce the feedback overhead by transmitting the common RI/PMI with almost the same performance with the individual RI/PMI feedback.

According to another exemplary embodiment, a method for further reducing a feedback amount in a case where different feedbacks share the RI/PMI in common while maintaining the individual CQI is described hereinafter. In order to further reduce the feedback amount, a feedback, other than the aforementioned reference feedback, includes only the difference between a corresponding CQI and the CQI of the reference feedback, and thus, does not include the CQI itself A case where the feedback FB 1 is the reference feedback and the feedback FB 2 is non-reference feedback and the sharing of the RI/PMI with FB 1 in Table 1 occurs is presented. In this case, assuming that a CQI determined for the feedback FB 1 is CQI1 and a CQI determined for the feedback FB 2 is CQI2, then the feedback FB 2 carries the difference between CQI1 and CQI2, i.e. CQI2-CQI1. Hereinafter, the difference acquired by subtracting the CQI for the non-reference feedback from the CQI for the reference feedback is referred to as delta_CQI. In Table 1, delta_CQI is determined according to CQI2-CQI1.

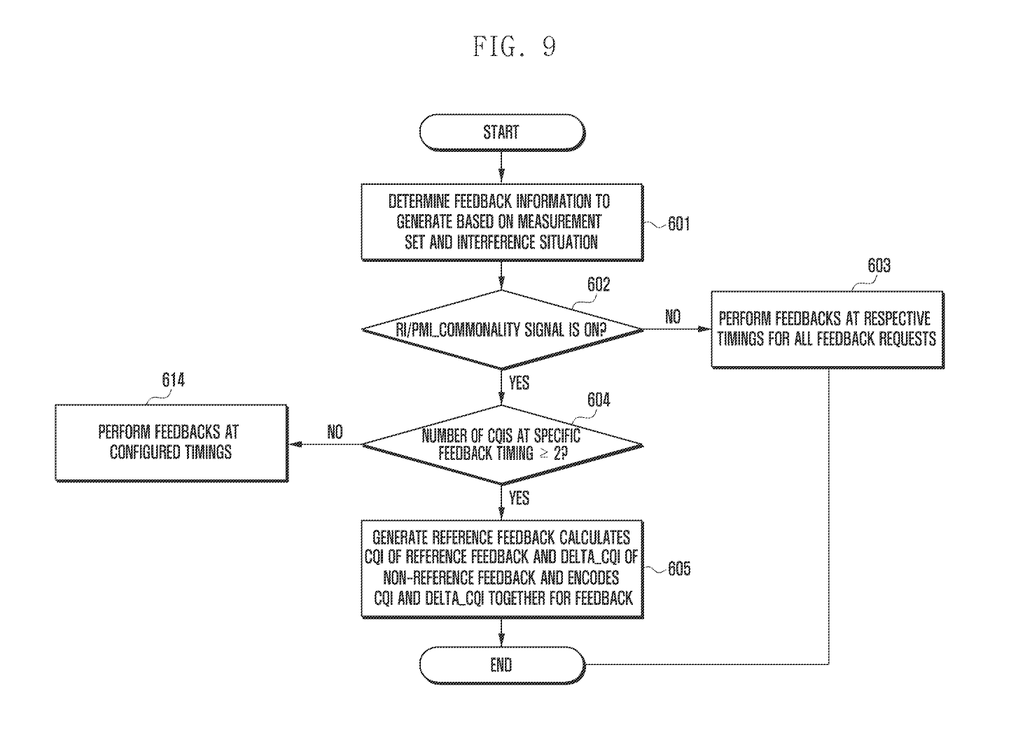

FIG. 9 is a flowchart illustrating a first method for a UE to feed back a delta_CQI to an eNB according to an exemplary embodiment of the present invention.

Referring to FIG. 9, the UE may detect a situation for feedback of delta_CQI and perform feedback to the eNB in various ways according to the first method. In the first method the UE generates, in the case that the feedbacks configured to share the RI/PMI are assigned the individual CQI transmission timings, the delta_CQI for the non-reference feedback in the timing when two or more CQI transmissions collide and to encode the delta_CQI and the CQI of the reference feedback together.

As shown in FIG. 9, the UE determines the feedback information to be generated based on the obtained measurement set and the interference situation at step 601. Next, the UE determines whether the RI/PMI_commonality signal is ON at step 602. According to an exemplary embodiment of the present invention, the UE may determine whether the feedbacks are configured to have at least one of the RI and the PMI.

If the RI/PMI_commonality signal is OFF, as determined at step 602, then the UE performs the feedbacks at the corresponding timings for all feedback requests at step 603. Otherwise if the RI/PMI_commonality is ON, as determined at step 602, then, at step 604, the UE determines whether a number of CQIs to be transmitted at a specific feedback transmission timing is equal to or greater than 2 and, if the number of CQIs is less than 2, performs the feedbacks at the corresponding feedback timings at step 614. Otherwise, if the number of CQIs is equal to or greater than 2, as determined at step 604, then the UE generates the reference feedback, calculates the CQI of the reference feedback and delta_CQI of the non-reference feedback, encodes the CQI of the reference feedback and the delta_CQI together, and performs feedback at the corresponding timing at step 605.

FIG. 9 is directed to a situation of feeding back the delta_CQI when two or more CQIs collide at a specific timing. In a normal situation having no CQI collision, however, the CQI for the non-reference feedback may be transmitted individually, or the delta_CQI may always be fed back even in a situation with no CQI collision.

Also, in the operations of FIG. 9 directed to the first method of delta_CQI feedback of the UE to the eNB, higher layer delta_CQI_configuration may be introduced such that UE uses the delta_CQI generation method of FIG. 9 when the delta_CQI_configuration is ON and skips the CQI transmission for the non-reference feedback in a collision situation when the delta_CQI_configuration is OFF.

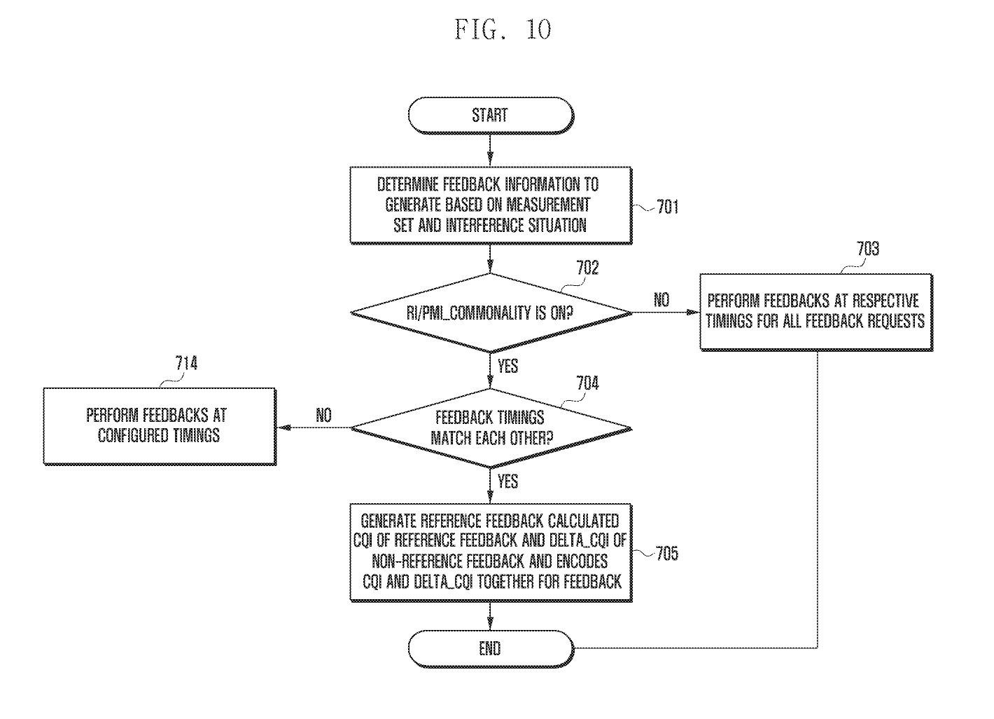

FIG. 10 is a flowchart illustrating a second method for a UE to feed back the delta_CQI to an eNB according to an exemplary embodiment of the present invention.

Referring to FIG. 10, the second method for the UE to detect the situation for feedback of the delta_CQI and perform feedback to the eNB is to generate, when the UE is configured such that the RI/PMI is common to the feedbacks at the same feedback timing, the delta_CQI for the non-reference feedback and to encode the CQI for the reference feedback and the delta_CQI together. In the present exemplary embodiment, the UE may feed back at least one of the RI and the PMI of the reference feedback for the feedbacks configured to have at least one of the RI and the PMI commonly.

That is, for the feedbacks configured to share RI/PMI and to have the same values defining the corresponding feedback timings, the UE generates all of the RI, the PMI, and the CQI for the reference feedback and performs the feedback at the corresponding feedback timings. However, for the non-reference feedback, the UE generates only the delta_CQI and encodes the delta_CQI along with the CQI for the reference feedback in order to perform feedback.

As shown in FIG. 10, the UE determines the feedback information to be generated based on the acquired measurement set and interference situation at step 701. Next, the UE determines whether the RI/PMI_commonality signal is ON at step 702. In the present exemplary embodiment, the UE may determine whether the feedbacks are configured to have at least one of the RI and the PMI in common.

If the RI/PMI_commonality signal is OFF, as determined in step 702, then the UE performs the feedbacks at the corresponding timings for all feedback requests at step 703. Otherwise, if the RI/PMI_commonality signal is ON, as determined in step 702, then the UE determines whether the feedbacks have the same feedback timing at step 704. If the feedbacks do not have the same feedback timing, as determined at step 704, then the UE, at step 714, performs feedbacks at the respective feedback timings for the feedbacks having different timings. Otherwise, if the feedbacks have the same feedback timing, as determined at step 704, then the UE generates the reference feedback, calculates the CQI of the reference feedback and the delta_CQI of the non-reference feedback, encodes the CQI for the reference feedback and the delta_CQI, and performs the feedback at the corresponding timing at step 705.

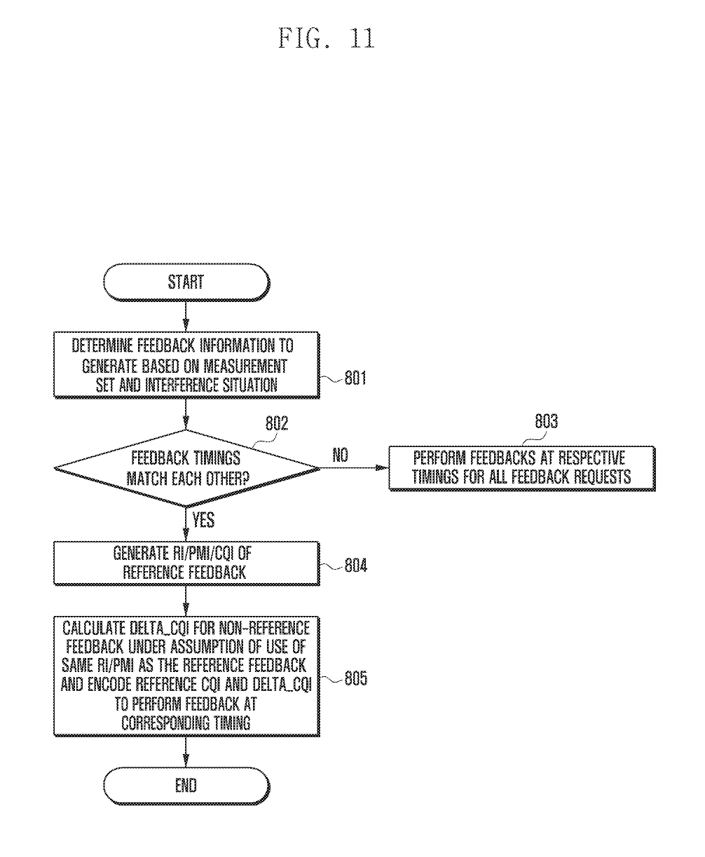

FIG. 11 is a flowchart illustrating the third method for the UE to feed back a delta_CQI to an eNB according to an exemplary embodiment of the present invention.

Referring to FIG. 11, the third method for the UE to detect the situation for feedback of the delta_CQI and perform feedback to the eNB is to generate, when the feedback timings are configured to match each other, all of the RI, the PMI, and the CQI for the reference feedback and the delta_CQI for the non-reference feedback and to encode the CQI of the reference feedback and the delta_CQI for the non-reference feedback to perform feedback. According to the present exemplary embodiment, the UE may feed back at least one of the RI and the PMI of the reference feedback for the non-reference feedbacks.

That is, for the feedbacks configured to have the same I_{CQI/PMI} and I_{RI} values defining the feedback timings, the UE generates all of the RI, the PMI, and the CQI for the reference feedback and performs feedback at the corresponding feedback timings. However, for the non-reference feedback, the UE generates only the delta_CQI and encodes the delta_CQI along with the CQI for the reference feedback to perform feedback.

As shown in FIG. 11, the UE determines the feedback information to be generated based on the acquired measurement set and interference situation at step 801. Next, the UE determines whether the feedbacks have feedback timings that match each other at step 802. If it is determined that the feedback timings do not match each other, in step 802, then the UE performs feedbacks at the respective feedback timings for all feedback requests having different timings.

In contrast, if it is determined, in step 802, that the feedback timings match each other, then the UE determines the reference feedback, calculates the CQI for the reference feedback and generates all of the RI, the PMI, and the CQI of the reference feedback at step 804. Next, the UE calculates the delta_CQI for the non-reference feedback under the assumption of use of the same RI/PMI as the reference feedback, and encodes the reference CQI for the reference feedback and the delta_CQI for the non-reference feedback to perform the feedback at the corresponding timing at step 805. In the present exemplary embodiment, the UE may assume that at least one of the RI and the PMI of the reference feedback is used in non-reference feedbacks in common.

In the methods of delta_CQI feedback of the UE to the eNB according to the exemplary embodiments of FIGS. 9 through 11, higher layer delta_CQI_configuration may be introduced such that UE uses the delta_CQI generation method when delta_CQI_configuration is ON and the UE skips CQI transmission for the non-reference feedback in a collision situation when delta_CQI_configuration is OFF.

Table 2 shows feedbacks in a situation where the UE acquires the measurement set {CSI-RS-1, CSI-RS-2}, CSI-RS-1 and CSI-RS-2 corresponding to respective Cell-1 and Cell-2, and is assigned a set of IMRs {IMR 1, IMR 2, IMR 3, IMR 4} for four different feedback requests. Each feedback is configured with separate timing information of I_{CQI/PMI} and I_{RI}.

TABLE 2

| Feedback | Signal component | Interference |
|---|---|---|
| FB 1 | Cell-1 | IMR 1 |
| FB 2 | Cell-1 | IMR 2 |
| FB 3 | Cell-2 | IMR 3 |
| FB 4 | Cell-2 | IMR 4 |

Table 2 summarizes feedback types for various signal and interference conditions. According to an exemplary embodiment of the present invention, the information listed in Table 2 may be referred to as feedback combination configurations which are transmitted from the eNB to the UE. In Table 2, the UE, in the feedback FB 1, measures the signal component at CSI-RS-1 corresponding to Cell-1 and interference at IMR 1 to generate feedback information and, in the feedback FB 2, measures the signal component at CSI-RS-1 and interference at IMR 2 of another interference situation to generate feedback information. In the feedback FB 3 and the feedback FB 4, the UE measures the signal component at the same CSI-RS resource but measures interference at different IMRs to generate feedback.

Like Table 1, the CSI transmitted in the feedback FB 1 or the feedback FB 2 may include the individual RI, PMI, and CQI or the common RI/PMI plus the individual CQI in Table 2. A determination as to whether to transmit the individual RI, PMI, and CQI or the common RI/PMI plus the individual CQI is based on the higher RRC signaling from the eNB. According to an exemplary embodiment of the present invention, the information included in the higher layer RRC signal is referred to as feedback report configuration. That is, assuming that there is a RRC signal named RI/PMI_commonality, if RI/PMI_commonality signal is ON, then the UE transmits one shared RI and PMI, but the individual CQI is transmitted individually and, otherwise if RI/PMI_commonality signal is OFF, then the UE transmits the individual RI, PMI, and CQI at individual feedback timings for feedbacks. According to an exemplary embodiment of the present invention, the UE may determine to share at least one of the RI and the PMI according to the RRC signal referred to as the RI/PMI_commonality signal.

Another method to determine whether to configure the CSI to include individual RI, PMI, and CQI or a common RI/PMI plus the individual CQI is to make the RI and the PMI common to the feedbacks having the same timing while generating the CQI individually and then encoding the common RI/PMI and the individual CQI to be fed back at the same timing. That is, if I_{CQI/PMI} and I_{RI} defining the timings in the feedback FB 1 and I_{CQI/PMI} and I_{RI} defining the timings in the feedback FB 2 are set to the same values, then the UE determines that the RI and the PMI are to be generated in common but that the CQI is to be generated individually and that they are to be encoded to be fed back at the same timings.

In the feedback including the common RI/PMI plus the individual CQI, the RI and the PMI to be referenced may be notified by the eNB through higher layer signaling or determined in an order of feedback request index.

In the following description, the feedback as the basis for generating the RI and the PMI in the common RI/PMI plus the individual CQI feedback schemes is referred to as the reference feedback. That is, if the higher layer signaling is used for notification of the reference feedback, then the eNB designates one of the feedback FB 1 and the feedback FB 2 for the common RI/PMI. Additionally, if the feedback request index is used, since the feedback FB 1 and the feedback FB 2 have indices 1 and 2 respectively, then the UE determines to share the RI and the PMI for the feedback FB 1 with a low index in common and to maintain the CQI for the feedback FB 2 with high index individually. Another method for determining the reference feedback of the RI/PMI is to use the indices of the IMRs for the interference components of the related feedbacks. For example, since the UE performs interference at the IMR 1 for the feedback FB 1 and the IMR 2 for the feedback FB 2, then the reference feedback is determined based on the RI/PMI of the feedback FB 1 with a low IMR index.

In the same way, the UE, in both the feedback FB 3 and the feedback FB 4, transmits the CSI generated based on the signal received from Cell-2 and interference received at the IMR 3 and the IMR 4. Since the feedback FB 3 and the feedback FB 4 are performed based on the same signal component but different interference components, the feedbacks may include the individual RI, PMI, and CQI or the common RI/PMI plus the individual CQI, like the feedback FB 1 and the feedback FB 2. That is, the feedback information may be configured with the common RI/PMI for the same signal component while having the individual CQI for each of the interference situations.

In the case of Table 2, in order to further reduce the feedback amount in transmitting the common RI/PMI plus the individual CQI, the delta_CQI may replace the CQI in specific feedback. In the case of Table 2, any of the methods described with reference to FIGS. 9, 10, and 11 may be applied as the method for the UE to detect the situation needing the delta_CQI transmission to the eNB and the performing of the feedback as in the situation of Table 1. In an exemplary embodiment of the present invention, a plurality of different feedbacks may have at least one of the RI and the PMI in common and while maintaining the CQI individually.

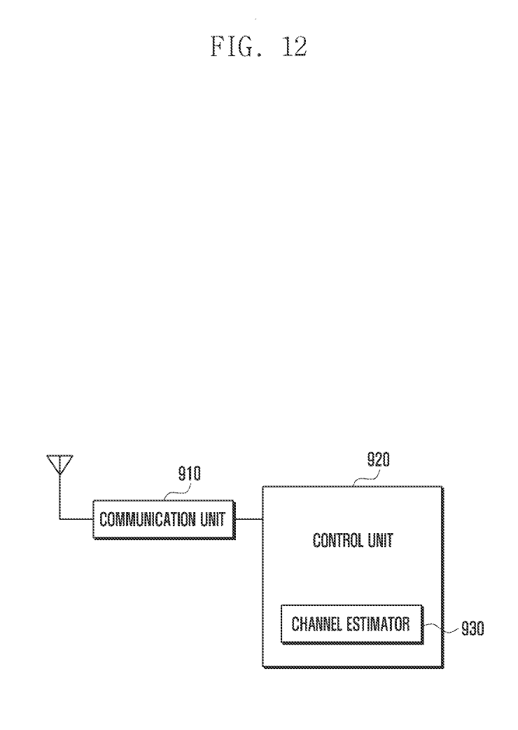

FIG. 12 is a block diagram illustrating a configuration of a UE according to an exemplary embodiment of the present invention.

Referring to FIG. 12, the UE includes a communication unit 910 and a control unit 920. The communication unit 910 transmits and receives data to and from the cellular mobile communication system. Here, the communication unit 910 may transmit the channel information for a CoMP technique to the central controller under the control of the control unit 920.

The control unit 920 controls the states and operations of all components constituting the UE. Here, the control unit 920 selects the feedback information for a CoMP transmission based on the information shared between the current UE and the cell and feeds back the channel information on the selected cell to the central controller. In order to accomplish this, the control unit 920 includes a channel estimator 930.

The channel estimator 930 determines the feedback information based on the measurement set and interference-related information received from the central controller and estimates the signal and interference using a received CSI-RS and IMR. The channel estimator 930 also controls the communication unit 910 to feed back the channel information related to CoMP.

Although the present exemplary embodiment is directed to the case where the UE is composed of the communication unit 910 and the control unit 920, the configuration of the UE is not limited thereto. That is, the UE may include further components responsible for various functions. For example, the UE may include a display unit for displaying a current UE state, an input unit for receiving the user input for executing a function, a storage unit for storing data generated by the UE, and any other similar and/or suitable elements that may be included in the UE.

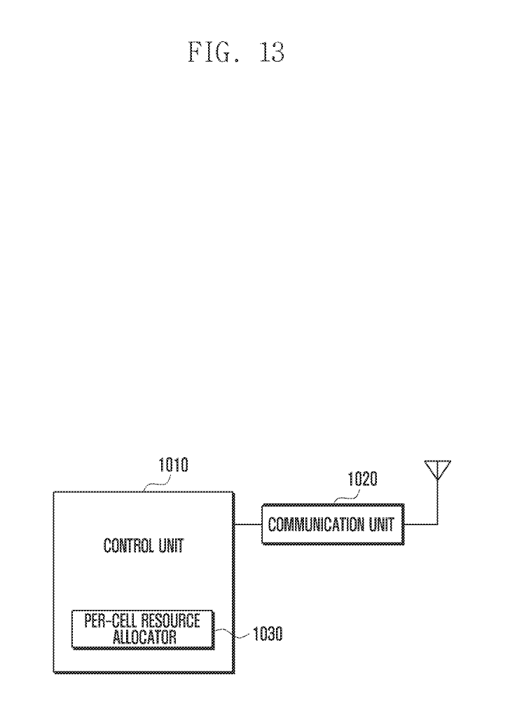

FIG. 13 is a block diagram illustrating a configuration of a central controller according to an exemplary embodiment of the present invention.

Referring to FIG. 13, the central controller includes a control unit 1010 and a communication unit 1020. The control unit 1010 controls the states and operations of all the components of the central controller. Here, the control unit 1010 allocates a CSI-RS resource and an IMR per cell for the UE's channel estimation. For this purpose, the control unit 1010 includes a per-cell resource allocator 1030.

The per-cell resource allocator 1030 allocates the CSI-RS resource in order for the UE to estimate channel of each cell and transmits the CSI-RS on the corresponding resource. The resource allocated per cell corresponds to the CSI-RS transmitted for channel estimation in the corresponding cell. The IMR is configured appropriately per UE for reflecting interference efficiently.

The communication unit 1020 is responsible for transmitting and receiving data to and from the UE or the cell managed by the central controller. Here, the communication unit 1020 transmits the CSI-RS and the IMR information to the UE on the allocated resource and receives the channel information feedback from the UE under the control of the control unit 1010.

According to the exemplary embodiments described above, neighbor cells are capable of transmitting data cooperatively to a UE located at a cell boundary through CoMP in a cellular mobile communication system. The cellular mobile communication system based on CoMP may provide enhanced mobile communication service as compared to a case without cooperation of cells. The UE may select the cells for transmitting the data dynamically at a cell boundary. Certain cells incurring interference may power off to support the cooperative transmission to the UE located at the cell edge. Since multiple cells transmit information to the cell edge UE simultaneously, it is possible to increase the information reception rate of the UE. In this way, the cellular mobile communication system is capable of serving all of the UEs at high data rate with fairness regardless of the location of the UE within a cell.

The specification and drawings are to be regarded in an illustrative rather than a restrictive sense in order to help understand the present invention. It is obvious to those skilled in the art that various modifications and changes can be made thereto without departing from the broader spirit and scope of the invention.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An interference measurement method of a terminal in a mobile communication system, the method comprising:
measuring a signal component based on at least one Channel Status Information-Reference Signal (CSI-RS) allocated by a base station;
measuring an interference component based on at least one Interference Measurement Resource (IMR) allocated by a base station;
receiving a feedback combination configuration of the signal component and the interference component;
generating feedback information including at least one of at least one Channel Quality Indicator (CQI), at least one Rank Indicator (RI), and at least one Precoding Matrix Indicator (PMI); and
transmitting the feedback information to the base station.

2. The method of claim 1, wherein the receiving of the feedback combination configuration comprises receiving a feedback report configuration.

3. The method of claim 1, wherein the transmitting of the feedback information comprises selecting one of the at least one generated RI as a selected reference RI and transmitting the selected reference RI to the base station.

4. The method of claim 3, wherein the selecting of the at least one generated RI as the selected reference RI comprises selecting the selected reference RI based on at least one of the feedback combination configuration and the feedback report configuration.

5. The method of claim 2, wherein the receiving of the feedback report configuration comprises receiving the feedback report configuration through Radio Resource Control (RRC) signaling.

6. The method of claim 2, wherein the transmitting of the feedback information comprises transmitting one of the at least one generated CQI.

7. An interference measurement method of a base station in a mobile communication system, the method comprising:
allocating at least one Channel Status Information-Reference Signal (CSI-RS) for measuring a signal component and at least one Interference Measurement Resource (IMR) for measuring an interference component to a terminal;
transmitting a feedback combination configuration of the signal component and the interference component; and
receiving feedback information including at least one of at least one Channel Quality Indicator (CQI), at least one Rank Indicator (RI), and at least one Precoding Matrix Indicator (PMI) generated by the terminal based on the feedback combination configuration.

8. The method of claim 7, wherein the transmitting of the feedback combination configuration comprises receiving a feedback report configuration.

9. The method of claim 7, wherein the receiving of the feedback report configuration comprises receiving a reference RI selected from among the at least one RI generated by the terminal.

10. The method of claim 9, wherein the terminal selects one of the at least one RI to be the reference RI based on at least one of the feedback combination configuration and the feedback report configuration.

11. The method of claim 8, wherein the receiving of the feedback report configuration comprises receiving the feedback report configuration through a Radio Resource Control (RRC) signaling.

12. The method of claim 8, wherein the terminal transmits a difference value that is a difference of two of the at least one CQI from among plural CQI values.

13. A terminal of a mobile communication system, the terminal comprising:
a transceiver transmitting and receiving signals to and from a base station; and
a control unit controlling measuring a signal component based on at least one Channel Status Information-Reference Signal (CSI-RS) allocated by a base station, measuring an interference component based on at least one Interference Measurement Resource (IMR) allocated by a base station, receiving a feedback combination configuration of the signal component and the interference component, generating feedback information including at least one of at least one Channel Quality Indicator (CQI), at least one Rank Indicator (RI), and at least one Precoding Matrix Indicator (PMI), and transmitting the feedback information to the base station.

14. The terminal of claim 13, wherein the control unit controls receiving a feedback report configuration.

15. The terminal of claim 13, wherein the control unit controls selecting one of the at least one generated RI as a selected reference RI and transmitting the selected reference RI to the base station.

16. The terminal of claim 15, wherein the control unit controls the selecting of the one of the at least one generated RI as the selected RI based on at least one of a feedback combination configuration and the feedback report configuration.

17. The terminal of claim 14, wherein the control unit controls the receiving of the feedback report configuration to be through Radio Resource Control (RRC) signaling.

18. The terminal of claim 14, wherein the control unit controls the transmitting of the feedback information to include transmitting one of the at least one generated CQI.

19. A base station of a mobile communication system, the base station comprising:
a transceiver transmitting and receiving signals to and from a terminal; and
a control unit controlling the transceiver, allocating at least one Channel Status Information-Reference Signal (CSI-RS) for measuring a signal component and at least one Interference Measurement Resource (IMR) for measuring an interference component to a terminal, transmitting a feedback combination configuration of the signal component and the interference component, and receiving feedback information including at least one of at least one Channel Quality Indicator (CQI), at least one Rank Indicator (RI), and at least one Precoding Matrix Indicator (PMI) generated by the terminal based on the feedback combination configuration.

20. The base station of claim 19, wherein the control unit controls receiving a feedback report configuration.

21. The base station of claim 19, wherein the control unit controls receiving, when the feedback report configuration is a specific value, a reference RI selected from among the at least one RI generated by the terminal.

22. The base station of claim 21, wherein the terminal selects one of the at least one RI to be the reference RI based on at least one of the feedback combination configuration and the feedback report configuration.

23. The base station of claim 20, wherein the control unit controls the receiving of the feedback report configuration signal to be through a Radio Resource Control (RRC) signaling.

24. The base station of claim 20, wherein the terminal transmits a difference value that is a difference of two of the at least one CQI from among plural CQI values.
